(19) United States
(12) Patent Application Publication
(10) Pub. No.: US 2009/0232504 A1
(43) Pub. Date: Sep. 17, 2009

(54) OPTICAL LINE TERMINATION, OPTICAL NETWORK UNIT, OPTICAL COMMUNICATION SYSTEM, TIMING CONTROL METHOD, AND RECORDING MEDIUM STORING PROGRAM FOR APPARATUS

(76) Inventor: KEN SHIRAISHI, Tokyo (JP)

Correspondence Address: NEC CORPORATION OF AMERICA, 6535 N. STATE HWY 161, IRVING, TX, 75039, US

(21) Appl. No.: 12/402,930

(22) Filed: Mar. 12, 2009

(30) Foreign Application Priority Data
Mar. 17, 2008 (JP) 2008-068163

(51) Int. Cl. H04J 14/08

(52) U.S. Cl. 398/98

(57) ABSTRACT

A plurality of lines which differ in transmission rate can coexist using a time division multiplexing (TDM) technique without any signal collision. An optical line termination (OLT) is connected to a plurality of lines which differ in transmission rate, and includes a timing extraction unit which extracts data transmission timing from a predetermined one of the plurality of lines and a timing allocation unit which allocates data transmission timing for a different line not to collide with the data transmission timing extracted by the timing extraction unit. An optical network unit (ONU) corresponding to the different line transmits data based on the allocated data transmission timing.

This application is based upon and claims the benefit of priority from Japanese patent application No. 2008-068163, filed on Mar. 17, 2008, the disclosure of which is incorporated herein in its entirety by reference.

### BACKGROUND OF THE INVENTION

1. Field of the Invention

The present invention relates to an optical line termination (OLT) which is connected to a plurality of lines which differ in transmission rate like a line of a Gigabit Ethernet (registered trademark)-passive optical network (GE-PON) and a line of 10GE-PON, an optical network unit (ONU), an optical communication system, a timing control method, and a recording medium storing a program of an apparatus.

2. Description of the Related Art

A GE-PON system and a 10GE-PON system are widely known.

FIG. 1 illustrates a configuration in which an existing GE-PON system and a 10GE-PON system coexist by a wavelength division multiplexing (WDM) filter. In a configuration of FIG. 1, a signal for an existing GE-PON OLT 604 and a signal for a 10GE-PON OLT 603 are multiplexed in a WDM filter 605 and coexist as a system.

As one related art of the present invention, there is a technique in which uplink data transmitted to an OLT are classified into a plurality of classes, a bandwidth is distributed according to each class, a bandwidth remaining after distribution is distributed to a plurality of optical network units (ONUs), and a Quality of Service (QoS) is provided according to a class priority (for example, see Japanese Patent Application Laid-Open No. 2007-97112).

As another related art of the present invention, there is a technique in which an OLT obtains a round trip time (RTT) with respect to a terminal apparatus, predicts a margin capable of absorbing a variation in a time stamp (TS) and distributes a gate frame to each terminal apparatus, so that a collision between uplink signals transmitted from terminal apparatuses is prevented even without a premise of clock synchronization (for example, see Japanese Patent Application Laid-Open No. 2007-295151).

Next, problems of the related arts described above will be described below.

First, in the GE-PON system illustrated in FIG. 1, it is difficult to multiplex different optical lines using a time division multiplexing (TDM) technique since synchronization is not made between optical lines. That is, if a line of the existing GE-PON OLT 604 and a line of the 10GE-PON OLT 603 are multiplexed by a TDM technique, there is a problem in that a signal collision occurs due to an overlap of an uplink allocation time of a PON line 608 since it is difficult to recognize an uplink band time which is allocated by a different type line as illustrated in FIG. 2.

In Japanese Patent Application Laid-Open No. 2007-97112 described above, a remaining band can be distributed while maintaining a QoS of a high priority class due to classification of uplink data, but a method for utilizing a plurality of lines which differ in transmission rate together has not been considered.

In Japanese Patent Application Laid-Open No. 2007-295151, a collision is avoided by providing distribution timing of a gate frame with a margin for absorbing a variation based on a round trip time, but a method for utilizing a plurality of lines which differ in transmission rate together without a data collision has not been considered.

### SUMMARY

The present invention is devised to resolve the above problems, and it is an object of the present invention to provide an optical line termination (OLT), an optical network unit (ONU), an optical communication system, a timing control method, and a recording medium storing a program for an apparatus in which a plurality of lines which differ in a transmission rate can be utilized together by a TDM technique without a signal collision.

According to the present invention, there is provided an optical line termination (OLT) which is connected to a plurality of lines which differ in transmission rate and includes a timing extraction unit which extracts data transmission timing from a predetermined one of the plurality of lines, and a timing allocation unit which allocates data transmission timing for a different line not to collide with the data transmission timing extracted by the timing extraction unit.

According to the present invention, there is also provided an optical network unit (ONU) which includes a frame transmission unit which transmits a frame at timing allocated by an optical line termination (OLT), and an identifier provision unit which includes an identifier which represents which line a frame transmitted by the frame transmission unit belongs to in the frame.

According to the present invention, there is also provided an optical communication system which includes a plurality of optical network units corresponding to one line, a plurality of optical networks units corresponding to a different line, an optical line termination corresponding to the different line which is connected to the plurality of optical network units corresponding to the one line and the plurality of optical networks units corresponding to the different line through an optical splitting unit, and an optical line termination corresponding to the one line which is connected to the optical line termination corresponding to the different line.

According to the present invention, there is also provided a method for controlling timing of an optical line termination which is connected to a plurality of lines which differ in transmission rate, including, extracting data transmission timing from a predetermined one of the plurality of lines, and allocating data transmission timing for a different line not to collide with the data transmission timing extracted by the extracting data transmission timing.

According to the present invention, there is also provided a recording medium storing a program of an optical line termination which is connected to a plurality of lines which differ in transmission rate, for executing, in a computer of the optical line termination, timing extraction processing which extracts data transmission timing from a predetermined one of the plurality of lines, and timing allocation processing which allocates data transmission timing for a different line not to collide with the data transmission timing extracted by the timing extraction unit.

According to the present invention, there is also provided a recording medium storing a program of an optical network unit, for allowing a computer of the optical network unit to function as a frame transmission unit which transmits a frame at timing allocated by an optical line termination (OLT), and an identifier provision unit which includes an identifier which represents which line a frame transmitted by the frame transmission unit belongs to in the frame.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram illustrating a configuration in which an existing GE-PON and a 10GE-PON coexist by a wavelength division multiplexing (WDM) according to a related art;

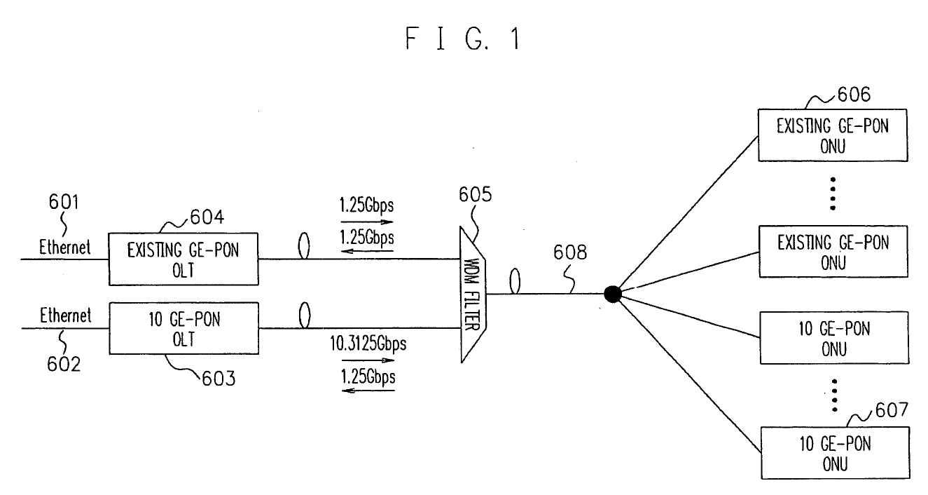

FIG. 2 is a diagram illustrating a collision between uplink signals in a system according to the related art;

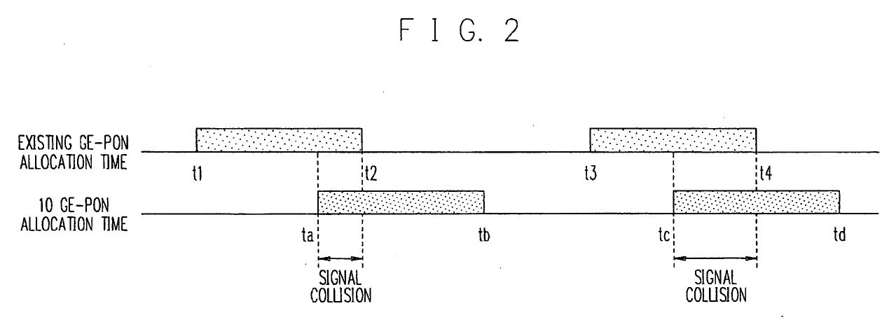

FIG. 3 is a schematic diagram illustrating the exemplary embodiment of the present invention;

FIG. 4 is a block diagram illustrating a configuration of an optical communication system according to the exemplary embodiment of the present invention;

FIG. 5 is a diagram illustrating uplink signals of a system according to the exemplary embodiment of the present invention;

FIG. 6 is a block diagram illustrating a configuration of a 10GE-PON MAC 306;

FIG. 7 illustrates a configuration of a preamble of an uplink signal transmitted from a 10GE-PON ONU 309;

FIG. 8 is a block diagram illustrating a configuration of a 10GE-PON ONU 309; and

FIGS. 9A and 9B illustrate uplink signals according to (A) a related art and uplink signals according to (B) the exemplary embodiment of the present invention, respectively.

### EXEMPLARY EMBODIMENT

Hereinafter, an exemplary embodiment in which an optical line termination (OLT), an optical network unit (ONU), an optical communication system, a timing control method, and a recording medium storing a program for an apparatus according to the present invention are applied to a GE-PON system will be described in detail with reference to the accompanying drawings.

First, the present embodiment will be briefly described below.

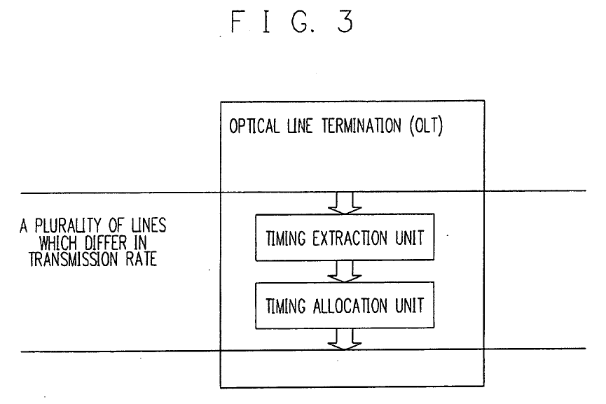

An OLT of the present embodiment is connected to a plurality of lines which differ in transmission rate and includes a timing extraction unit which extracts data transmission timing from a predetermined one among a plurality of lines as illustrated in FIG. 3. The OLT further includes a timing allocation unit which allocates data transmission timing for a different line not to collide with data transmission timing extracted by the timing extraction unit. An ONU corresponding to the different line performs data transmission based on the allocated data transmission timing.

A GE-PON system is a TDM-based system in which an OLT which is a central office side apparatus allocates a time axis for an uplink band to each ONU for uplink data transmission.

An existing GE-PON system uses WDM multiplexing for downlink transmission but TDM multiplexing for uplink transmission when an asymmetric system such as a 10GE-PON system (uplink 1.25 Gbps and downlink 10.3125 Gbps) is adopted. However, TDM multiplexing cannot avoid a signal collision if a time axis is not synchronized between an existing GE-PON line (one line) and a 10GE-PON line (different line).

In the present embodiment, an asymmetric GE-PON system and an existing GE-PON system can coexist by avoiding a signal collision in TDM multiplexing of an uplink direction.

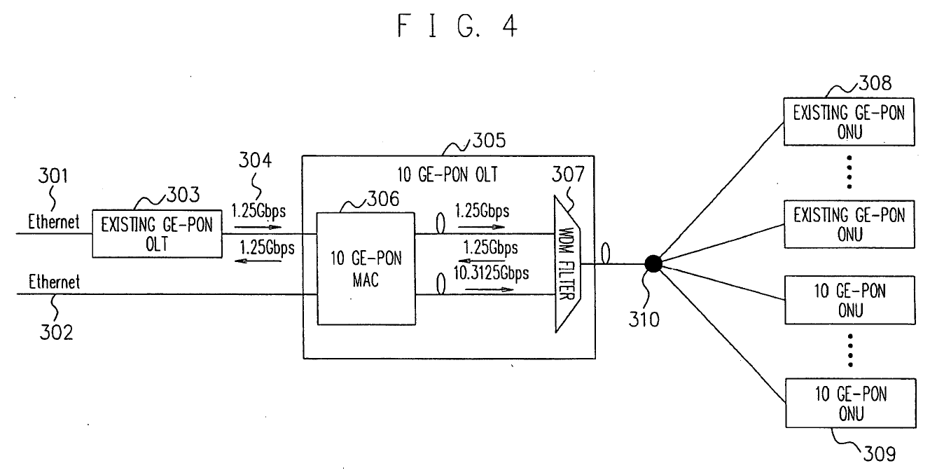

FIG. 4 is a diagram illustrating one example of a configuration of an optical communication system in which a 10GE-PON system and an existing GE-PON system are synchronized.

The optical communication system of the present embodiment has a configuration in which an existing GE-PON OLT 303 and a 10GE-PON OLT 305 are serially connected, and the 10GE-PON OLT 305 is connected to an existing GE-PON ONU 308 and a 10GE-PON ONU 309 through a WDM filter 307 and a photo coupler (photo splitter) 310 as illustrated in FIG. 4.

A 10GE-PON media access control (MAC) function 306 monitors a downlink multi-point control protocol (MPCP) frame of an existing GE-PON line connected thereto, and extracts localtime of the existing GE-PON OLT 303 and an allocation time for the existing GE-PON ONU 308.

The 10GE-PON media access control (MAC) function 306 computes a band used by the existing GE-PON line based on extracted data and notifies an allocation band/time of the 10GE-PON ONU 309 so that a signal collision does not occur. The 10GE-PON media access control (MAC) function 306 extracts a clock from a receiving signal 304 of the existing GE-PON OLT 303 and controls localtime using the extracted clock to synchronize localtime.

The existing GE-PON system is influenced when the 10GE-PON OLT 305 outputs output data of the 10GE-PON ONU 309 to the existing GE-PON OLT 303. In order to resolve this problem, in the optical communication system of the present embodiment, an identification (ID) code is included in a preamble of an uplink signal transmitted from the 10GE-PON ONU 309, and the 10GE-PON MAC 306 distributes data based on the identification code. Accordingly, the 10GE-PON line and the existing GE-PON line can coexist by a TDM technique with respect to an uplink signal without influencing the existing GE-PON system.

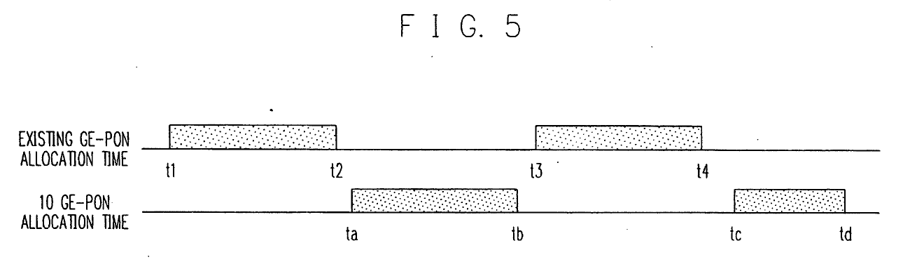

According to the configuration of the present embodiment, as illustrated in FIG. 5, a collision of uplink signals of the existing GE-PON and the 10GE-PON can be avoided, whereby the existing GE-PON is not influenced.

Next, an operation for synchronizing localtime between the existing GE-PON system and the 10GE-PON system will be described with reference to FIG. 4.

The 10GE-PON OLT 305 receives a signal of 1.25 Gbps from the existing GE-PON OLT 303 as a downlink signal, and the 10GE-PON MAC function 306 extracts a clock and a MPCP frame of the existing GE-PON OLT 303.

The 10GE-PON MAC 306 outputs data to be transmitted to the existing GE-PON ONU 308 to the WDM filter 307 at a fixed delay. The WDM filter 307 multiplexes an output of the existing GE-PON line and an output of the 10GE-PON line by a WDM technique and outputs to a PON domain.

The output of the existing GE-PON line and the output of the 10GE-PON line which has been multiplexed by a WDM technique as described above are data-transmitted to the existing GE-PON ONU 308 and the 10GE-PON ONU 309 through the photo coupler 310, respectively. The existing GE-PON ONU 308 and the 10GE-PON ONU 309 perform reception processing by extracting a necessary wavelength through a filter, respectively.

Each existing GE-PON ONU 308 turns on a laser at timing (time slot) allocated from the existing GE-PON OLT 303 to output an uplink signal. Each 10GE-PON ONU 309 turns on a laser at timing (time slot) allocated from the 10GE-PON MAC 306 to output an uplink signal.

The 10GE-PON ONU 309 includes an identifier which represents a 10GE-PON ONU output in a preamble of output data. The 10GE-PON MAC 306 distributes to an existing GE-PON OLT 303 output and a 10GE-PON MAC 306 internal processor using the identifier.

The 10GE-PON OLT 305 outputs an uplink output to the existing GE-PON OLT 303 through a 1.25 Gbps line 304, and the existing GE-PON OLT 303 receives and internally processes the uplink output.

In data of 10GE-PON MAC 306 internal processing, termination is performed in the 10GE-PON MAC 306 as PON-related processing, and data is output to an upper level device through an Ethernet (registered trademark)-based network line 302.

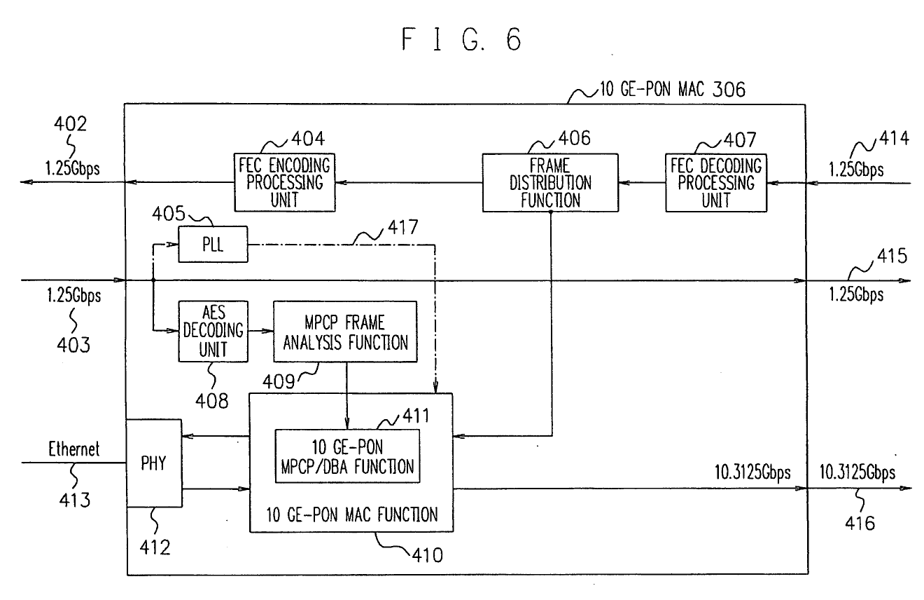

Next, an operation of the 10GE-PON OLT 305 according to the present embodiment will be described with reference to an internal configuration of the 10GE-PON MAC 306 illustrated in FIG. 6.

First, downlink processing will be described below.

As illustrated in FIG. 6, the 10GE-PON MAC 306 receives a downlink signal from the existing GE-PON system through a 1.25 Gbps line 403. A phase locked loop (PLL) 405 extracts an operation clock of the existing GE-PON system from the received signal and generates a clock 417 which is synchronized with the clock (synchronous clock generating unit). A 10GE-PON MAC function 410 controls localtime using the synchronous clock transmitted from the PLL 405.

An advanced encryption standard (AES) decoding unit 408 extracts an MPCP frame from a signal transmitted from the existing GE-PON line and outputs the MPCP frame to an MPCP frame analysis function 409. The MPCP frame analysis function 409 analyzes the extracted MPCP frame, timestamp, and information about a band allocation for the existing GE-PON ONUs (timing extraction unit).

The MPCP frame analysis function 409 notifies the analysis result to a 10GE-PON MPCP/DBA (Dynamic Bandwidth Allocation) function 411. The 10GE-PON MPCP/DBA function 411 computes a remaining band based on the analysis result and computes a band allocation for a 10GE-PON ONU. An MPCP frame is generated not cause a signal collision with the existing GE-PON line, and the 10GE-PON MPCP/DBA function 411 outputs a downlink signal to a 10GE-PON line side 416 from the 10GE-PON MAC function 410 (timing allocation unit). That is, the 10GE-PON MPCP/DBA function 411 notifies data transmission timing of each 10GE-PON ONU 309 to each 10GE-PON ONU 309.

A downlink signal 403 of the existing GE-PON is output to a GE-PON line 415 side at a fixed delay.

Next, uplink processing will be described below.

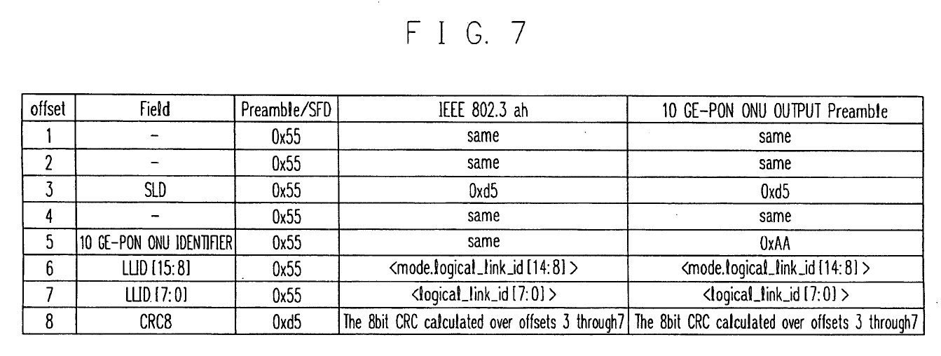

The 10GE-PON ONU 309 includes an identifier of a 10GE-PON ONU in an offset 5 of a preamble when outputting a signal to a PON line as illustrated in FIG. 7.

The 10GE-PON MAC function 306 receives signals transmitted from a GE-PON line 414, that is, data of an uplink signal from the existing GE-PON ONU 308 and data of an uplink signal from the 10GE-PON ONU 309 as signals which are TDM-multiplexed.

If the received signal is a forward error correction (FEC) frame, a FEC decoding processing unit 407 perform error correction processing and outputs the processed signal to a frame distribution function (distribution unit) 406.

The frame distribution function 406 discriminates a signal from the existing GE-PON ONU 308 and a signal from the 10GE-PON ONU 309 using information of the preamble, and distributes an output for the existing GE-PON line and an output for the 10GE-PON MAC function 410.

By the distribution, a signal from the existing GE-PON ONU 308 is output to a FEC encoding processing unit 404. The FEC encoding processing unit 404 performs FEC encoding processing of data in which error correction has been performed by the FEC decoding processing unit 407 and outputs to an existing GE-PON line 402.

In a signal outputted to the 10GE-PON MAC function 410 by the distribution of the frame distribution function 406, an MPCP frame is processed in the 10GE-PON MPCP/DBA function 411. The 10GE-PON MAC function 410 outputs a signal to be transmitted to an upper level device to an Ethernet-based network line 413 through a physical layer (PHY) 412.

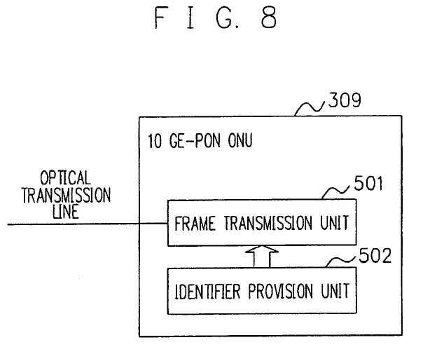

The 10GE-PON ONU 309 according to the present embodiment includes a frame transmission unit 501 which transmits a frame at timing allocated by the 10GE-PON OLT 305 in the above-described method as illustrated in FIG. 8. The 10Ge-PON ONU 309 further includes an identifier provision unit 502 which includes an identifier, which represents which line a transmission frame belongs to, in a predetermined portion of a preamble of a transmission frame as illustrated in FIG. 7.

By the configuration described above, the 10GE-PON ONU 309 according to the present embodiment transmits a frame including an identifier which represents a 10GE-PON line as an uplink signal at timing allocated by the 10GE-PON OLT 305.

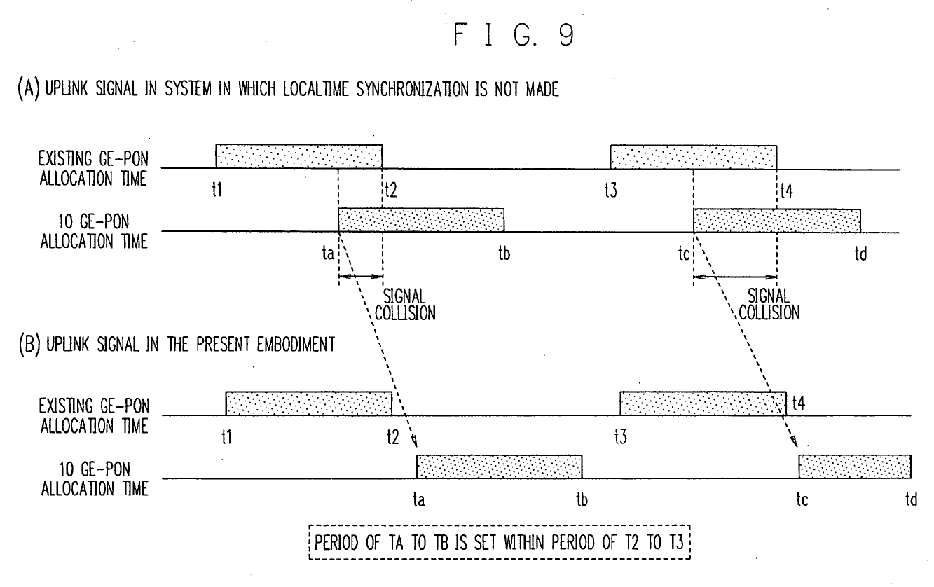

As described above, according to the present embodiment, a system in which an existing GE-PON and a 10GE-PON coexist is configured, and a 10Ge-PON OLT is synchronized with localtime of an existing GE-PON, so that an uplink band of a 10GE-PON ONU is allocated at a remaining band of an uplink signal of an existing GE-PON as illustrated in FIG. 9B.

Therefore, a 10GE-PON MAC side can recognize localtime and an allocation band time of an existing GE-PON system and so can allocate a signal allocation time of a 10GE-PON line not to collide with a signal allocation time of an existing GE-PON line.

For a signal allocation of a 10GE-PON line to “a remaining band” described above, the total number of ONUs can be determined when a system is designed, and the number of existing GE-PON ONUs 308 and the number of 10GE-PON ONUs 309 are allocated at that time. Therefore, it is possible to make a design in which TDM-multiplexed lines are balanced in band without eliminating a band of a 10GE-PON line.

In the present embodiment, a band of a 10GE-PON ONU is allocated at a remaining band of an existing GE-PON by synchronizing a 10GE-PON OLT with localtime of an existing GE-PON, so that a 10GE-PON can be installed in an existing GE-PON system. Accordingly, uplink signals of systems which differ in transmission rate can exist by TDM multiplexing.

Also, in the present embodiment, an existing GE-PON uplink signal and a 10GE-PON uplink signal are discriminated by an identification code included in a predetermined portion of a preamble of an uplink signal, so that a 10GE-PON system can coexist with an existing GE-PON system without influencing an existing GE-PON system.

According to the embodiment described above, the following effects are obtained.

A first effect is that an existing GE-PON line and a 10GE-PON line can coexist, and also TDM multiplexing can be performed in an uplink direction of an existing GE-PON system.

A second effect is that a 10GE-PON system can be provided as a supplemental service without influencing an existing GE-PON system.

A third effect is that a downlink 10G service can be provided in a state in which a resource of an existing GE-PON system is diverted.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, in the embodiment described above, an uplink signal of an existing GE-PON line and an uplink signal of a 10GE-PON line are multiplexed by a TDM, but the present invention is not limited to it and can be applied to various systems in which uplink signals of a plurality of lines which differ in system are multiplexed by a TDM if uplink signals are synchronized and can be multiplexed by a TDM.

Further, the present invention is not limited to a GE-PON illustrated in the embodiment described above and can be applied to various passive optical networks (PONs) Also, since a downlink signal is multiplexed by a WDM, the embodiment described above has been described using two lines of 10GE-PON=1.55 μm and GE-PON=1.31 μm, but the present invention is not limited to it and can be applied to ones which use various wavelengths if only uplink signals multiplexed by a TDM are synchronized.

In the embodiment described above, two lines which are 1 Gb/s and 10 Gb/s in downlink transmission rate have been described, but the present invention is not limited to it, and lines with various transmission rates may be used if uplink signals multiplexed by a TDM are the same in uplink transmission rate as each other.

Also, if an uplink transmission rate is acceptable within an allocated time slot like the embodiment described above, the present invention can be applied even though uplink signals multiplexed by a TDM are different in transmission rate.

In the embodiment described above, optical communication lines of two different transmission rates of 1 Gb/s and 10 Gb/s are multiplexed, but the present invention can be applied to a system in which OLTs with different transmission rates are serially connected, and systems of three or more different transmission rates are multiplexed and coexist. For example, a configuration in which OLTs are serially connected like “existing GE-PON (1 Gb/s)”→“10GE-PON (10 Gb/s)”→“20GE-PON (20 Gb/s)” as an extension of the configuration illustrated in FIG. 4 is possible.

A processing procedure for implementing an OLT, an ONU and an optical communication system according to the embodiment described above can be recorded on a recording medium as a program, and the above-described functions according to the embodiment of the present invention can be realized in such a way that a program supplied from a recording medium allows a central processing unit (CPU) of a computer which configures a system to perform corresponding processing. In this case, even though an information group including a program is supplied to an output device from the recording medium described above or an external recording medium through a network, the present invention can be applied.

That is, a program code read from a recording medium realizes novel functions of the present invention, and a recording medium storing the program code and signals read from the recording medium configure the present invention. As the recording medium, for example, a flexible disk, a hard disk, an optical disk, an optical magnetic disk, CD-ROM, CD-R, CD-RW, DVD-ROM, DVD-RAM, DVD-RW, DVD+RW, a magnetic tape, a non-volatile memory card, and a ROM may be used.

According to the recording medium which stores a program according to the present invention, the functions of the embodiment described above can be realized in an OLT, an ONU, and an optical communication system which are controlled by the recorded program.

As described above, according to the present invention, a plurality of lines which differ in transmission rate can coexist using a TDM technique without any signal collision.

What is claimed is:

1. An optical line termination (OLT) which is connected to a plurality of lines which differ in transmission rate, comprising:
a timing extraction unit which extracts data transmission timing from a predetermined one of the plurality of lines; and
a timing allocation unit which allocates data transmission timing for a different line not to collide with the data transmission timing extracted by the timing extraction unit.

2. The optical line termination of claim 1, further comprising, a distribution unit which identifies which one among the plurality of lines a frame belongs to based on an identifier included in the frame and performs distribution of a frame destination, the frame transmitted from one of the plurality of lines which is multiplexed by a time division multiplexing (TDM) and is transmitted at timing allocated by the timing allocation unit.

3. The optical line termination of claim 2, wherein the identifier is included in a predetermined portion of a preamble of the frame.

4. The optical line termination of claim 1, wherein uplink signals of the plurality of lines are multiplexed by a time division multiplexing (TDM), and
the timing allocation unit performs a timing allocation by transmitting data transmission timing of the different line to an optical network unit corresponding to the different line.

5. The optical line termination of claim 1, further comprising, a synchronous clock generation unit which extracts an operation clock of the one line from the one line and generates a synchronous clock which is synchronized with the operation clock, wherein the timing allocation unit controls data transmission timing of the different line based on the synchronous clock.

6. An optical network unit (ONU), comprising:
a frame transmission unit which transmits a frame at timing allocated by an optical line termination (OLT); and
an identifier provision unit which includes an identifier which represents which line a frame transmitted by the frame transmission unit belongs to in the frame.

7. The optical network unit of claim 6, wherein the identifier is included in a predetermined portion of a preamble of the frame.

8. An optical communication system, comprising:
a plurality of optical network units corresponding to one line;
a plurality of optical network units corresponding to a different line;
an optical line termination corresponding to the different line which is connected to the plurality of optical network units corresponding to the one line and the plurality of optical network units corresponding to the different line through an optical splitting unit; and
an optical line termination corresponding to the one line which is connected to the optical line termination corresponding to the different line,
wherein the optical network unit corresponding to the different line includes
a frame transmission unit which transmits a frame at timing allocated by an optical line termination, and
an identifier provision unit which includes an identifier which represents which line a frame transmitted by the frame transmission unit belongs to in the frame, and
the optical line termination corresponding to the different line is connected to a plurality of lines which differ in transmission rate and includes
a timing extraction unit which extracts data transmission timing from a predetermined one of the plurality of lines, and a timing allocation unit which allocates data transmission timing corresponding to a different line not to collide with the data transmission timing extracted by the timing extraction unit.

9. A method for controlling timing of an optical line termination which is connected to a plurality of lines which differ in transmission rate, comprising:
extracting data transmission timing from a predetermined one of the plurality of lines; and
allocating data transmission timing for a different line not to collide with the data transmission timing extracted by the extracting data transmission timing.

10. The method for controlling timing of claim 9, further comprising, identifying which one among the plurality of lines a frame belongs to based on an identifier included in the frame and performing distribution of a frame destination, the frame transmitted from one of the plurality of lines which are multiplexed by a time division multiplexing (TDM) and is transmitted at timing allocated by the allocating data transmission timing.

11. The method for controlling timing of claim 10, wherein the identifier is included in a predetermined portion of a preamble of the frame.

12. The method for controlling timing of claim 9, wherein uplink signals of the plurality of lines are multiplexed by a time division multiplexing (TDM), and
data transmission timing of the different line allocated by the allocating data transmission timing is notified to the optical network unit corresponding to the different line.

13. The method for controlling timing of claim 9, further comprising, extracting an operation clock of the one line from the one line and generating a synchronous clock which is synchronized with the operation clock,
wherein the allocating data transmission timing comprises controlling data transmission timing of the different line based on the synchronous clock.

14. A recording medium storing a program of an optical line termination which is connected to a plurality of lines which differ in transmission rate, for executing, in a computer of the optical line termination:
timing extraction processing which extracts data transmission timing from a predetermined one of the plurality of lines; and
timing allocation processing which allocates data transmission timing for a different line not to collide with the data transmission timing extracted by the timing extraction unit.

15. The recording medium storing a program of an optical line termination of claim 14, wherein the program further executes, in the computer of the optical line termination, distribution processing which identifies which one among the plurality of lines a frame belongs to based on an identifier included in the frame and performs distribution of a frame destination, the frame transmitted from one of the plurality of lines which are multiplexed by a time division multiplexing (TDM) and is transmitted at timing allocated by the timing allocation processing.

16. The recording medium storing a program of an optical line termination of claim 15, wherein the identifier is included in a predetermined portion of a preamble of the frame.

17. The recording medium storing a program of an optical line termination of claim 14, wherein uplink signals of the plurality of lines are multiplexed by a time division multiplexing (TDM), and
notification processing which notifies data transmission timing of the different line allocated by the timing allocation processing to an optical network unit corresponding to the different line is executed in the computer of the optical line termination.

18. The recording medium storing a program of an optical line termination of claim 14, wherein the program further executes, in the computer of the optical line termination, synchronous clock generation processing which extracts an operation clock of the one line from the one line and generates a synchronous clock which is synchronized with the operation clock, and
the timing allocation processing includes controlling data transmission timing of the different line based on the synchronous clock.

19. A recording medium storing a program of an optical network unit, for allowing a computer of the optical network unit to function as
a frame transmission unit which transmits a frame at timing allocated by an optical line termination (OLT), and as an identifier provision unit which includes an identifier which represents which line a frame transmitted by the frame transmission unit belongs to in the frame.

20. The recording medium storing a program of an optical network unit of claim 19, wherein the identifier is included in a predetermined portion of a preamble of the frame.

21. An optical line termination (OLT) which is connected to a plurality of lines which differ in transmission rate, comprising:
timing extraction means for extracting data transmission timing from a predetermined one of the plurality of lines; and
timing allocation means for allocating data transmission timing for a different line not to collide with the data transmission timing extracted by the timing extraction means.

22. An optical network unit (ONU), comprising:
frame transmission means for transmitting a frame at timing allocated by an optical line termination (OLT); and
identifier provision means for including an identifier which represents which line a frame transmitted by the frame transmission means belongs to in the frame.
